(19) United States
(12) Patent Application Publication
(10) Pub. No.: US 2010/0018024 A1
(43) Pub. Date: Jan. 28, 2010

(54) THROTTLE PASSAGE WHISTLING CONTROL DEVICE AND METHOD

(76) Inventor: ROBERT D. GARRICK, Rochester, NY (US)

Correspondence Address: Delphi Technologies, Inc., M/C 480-410-202, PO BOX 5052, Troy, MI, 48007, US

(21) Appl. No.: 12/570,417

(22) Filed: Sep. 30, 2009

Related U.S. Application Data
(62) Division of application No. 11/206,509, filed on Aug. 18, 2005.

(51) Int. Cl. B23P 6/00

(52) U.S. Cl. 29/402.19

(57) ABSTRACT

Unwanted high frequency sound caused by air passing over a pore in the air passageway of an IACV casting is reduced or eliminated by creating a stepped diameter adjacent the pore in the air passageway.

### TECHNICAL FIELD

The present invention relates to noise control devices and methods in air passageways, and more particularly relates to such devices and methods applied to an idle air control valve passageway used in internal combustion engines.

### BACKGROUND OF THE INVENTION

Idle air control valves (hereinafter “IACVs”) are used to bypass closed or partly closed throttle body plates in order to provide air to engines while running at idle speeds. The IACV operates in response to pressure changes or signals received from the engine control unit to maintain the proper idle operating speed of the engine. In certain engine designs (e.g., GM 3.1/3.4 L engines), the throttle body and IACV air passageway are cast as a single unit out of an appropriate metal or metal alloy such as aluminum, for example. These single cast units have varying wall thicknesses, which can cause different shrinkage rates during curing of the unit. Different shrinkage rates can lead to a phenomenon known as “shrink porosity” where thicker parts of the casting have open spaces or pores in the metal due to the fact they cure more slowly than the thinner parts of the casting. While these pores do not adversely affect the operating performance of the casting, they have been a source of unwanted noise emanating from the air passageway, which is incorporated into the casting. In particular, a high frequency whistling sound may be generated when air passes over the area of the pore. This whistling sound, while innocuous to engine performance, may be interpreted as a defect or at least an annoyance to the consumer. It is therefore in the manufacturer's best interest to eliminate this noise.

### SUMMARY OF THE INVENTION

The present invention addresses the above problem by reducing or eliminating high frequency sounds caused by pores formed during casting of an air valve. While the invention is applicable to any type of air valve which generates unwanted noise caused by pores in the air passageway, a specific application of the present invention is to reduce or eliminate noise caused by pores in an IACV passageway.

In certain engine designs, the throttle body and IACV passageway are cast as a single unit and the area adjacent the IACV passageway is thicker than other areas of the unit. As such, the casting process may introduce pores in the area of the IACV due to a phenomenon known in the casting art as shrink porosity. Following casting, the air passageway of the IACV is typically machined to achieve the desired dimensions thereof. The machining operation reveals pores formed in the casting and pores hence become located in the surface of the air passageway of the IACV. As air travels over a pore, a high frequency sound is generated and is heard as a whistle. The present invention substantially reduces or eliminates this sound by forming a step in the diameter of the air passageway adjacent the pore. This step causes a beneficial change in the air velocity vectors at this location. Particularly, the step configuration of the passageway causes a recirculation zone at the pore which substantially reduces or eliminates the high frequency sound. The step may be formed with a conventional step drill at the time of machining the air passageway for the IACV. It will thus be appreciated that the present invention solves a major problem with no appreciable cost added to the manufacturing process.

### BRIEF DESCRIPTION OF THE DRAWINGS

The present invention will now be described, by way of example, with referenced to the accompanying drawings, in which:

FIG. 1 is a perspective view, partly in cross-section, of a throttle body having an integral IACV passageway.

### DETAILED DESCRIPTION OF A PREFERRED EMBODIMENT

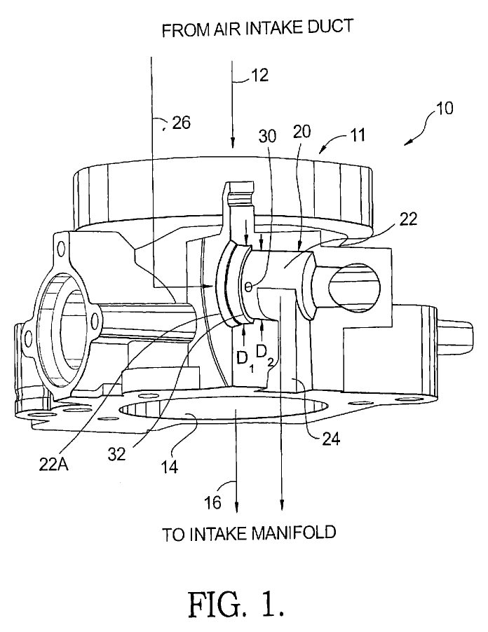

Referring now to the drawing, there is seen in FIG. 1 a throttle body indicated generally by the reference numeral 10. Throttle body 10 is used to meter air to an engine (not shown) and includes a throttle plate (not shown) that pivots inside the body cavity 11 between open and closed positions to regulate the amount of air that reaches the engine. Thus, air is delivered to throttle body 10 from the air intake duct as represented by arrow 12, travels past the throttle plate (when it is open), through the throttle body passageway 14, and is directed through appropriate tubing (not shown) to the engine's intake manifold as represented by arrow 16. This aspect of the throttle body is conventional and well known to those skilled in the art.

Throttle body 10 includes an integrally formed idle air control valve (IACV) passageway 20 having an inlet passageway 22 leading to an outlet passageway 24 and ultimately to the intake manifold. The IACV itself is not shown but is fitted to the inlet passageway opening 22A. In operation, when the engine is at idle speed, air from the intake duct travels through appropriate tubing and the IACV into the IACV intake passageway 20 as represented by arrow 26. The IACV itself is conventional and operates to allow air to bypass the closed throttle plate and provide air to the engine when at idle speed.

The IACV passageway 20 (shown in cross-section) is typically formed by the mold during casting of the throttle body 10. Following the casting operation, a machining operation refines and sets the desired diameter of IACV passageway 20. As explained above, the machining operation reveals pores in the surface of the passageway that were formed during casting and cooling due to a phenomenon known as “shrink porosity”. A representation of such a pore is indicated at reference numeral 30. Without the benefit of the present invention, the pore 30 would create an undesirable whistling sound as air passes thereover. The present invention eliminates or at least substantially reduces this undesirable sound by forming a stepped diameter adjacent pore 30 as indicated by reference numeral 32. This stepped diameter may be easily formed with a step drill during the machining of the passageway 20 as described above. The stepped diameter has a diameter D₁ which is preferably in the range of about 0.2 mm to about 10 mm larger than the base diameter D₂, is more preferably in the range of about 0.5 mm to about 5.0 mm larger than the base diameter, and is most preferably about 1.5 mm larger than the base diameter. Furthermore, the stepped diameter 32 is formed adjacent pore 30, preferably in the range of about 0.2 mm to about 10 mm from pore 30, is more preferably in the range of about 0.5 mm to about 5.0 mm from pore 30, and is most preferably about 1.5 mm from pore 30. The stepped diameter 32 creates a recirculation zone in the vicinity of pore 30, thereby eliminating or at least substantially reducing the undesirable sound.

It will thus be appreciated that the present invention provides an easy and inexpensive method of eliminating or at least substantially reducing an undesirable sound caused by a pore in an air passageway of an engine component. Although the invention has been described with reference to an IACV passageway in a throttle body, it is understood that the invention is useful for any type of component having an air passageway where the benefits of the present invention may be realized.

1. A method of reducing or eliminating unwanted sound caused by air passing over a void exposed in the wall of an air passageway, said method comprising the step of creating a stepped diameter in the wall of the passageway adjacent said void.

2. The method of claim 1 wherein said air passageway is part of an idle air control valve.

3. The method of claim 1 wherein said stepped diameter is formed with a step drill.

4. The method of claim 1 wherein said stepped diameter is about 0.2 mm to about 10 mm larger than the base diameter of said air passageway at the location of said void.

5. The method of claim 1 wherein the stepped diameter is about 0.5 mm to about 5 mm larger than the base diameter of said air passageway at the location of said void.

6. The method of claim 1 wherein the stepped diameter is about 5 mm larger than the base diameter of the passageway at the location of said void.

7. The method of claim 1 wherein said void is caused by shrink porosity during casting of said wall and said void is exposed at the surface of said air passageway as a result of a machining operation that removes material from the surface of said wall.

8. The method of claim 2 wherein said idle air control valve is cast as a single unit together with a throttle body.

9. The method of claim 6 wherein said single unit is cast from aluminum.

10. The method of claim 1 wherein said passageway is cast as part of a throttle body and said void is caused by shrink porosity during casting of said unit.

11. The method of claim 1 wherein said stepped diameter is located about 0.2 mm to about 10 mm from said void.

12. The method of claim 1 wherein said stepped diameter is located about 0.5 mm to about 5 mm from said void.

13. The method of claim 1 wherein said stepped diameter is located about 1.5 mm from said void.

14-19. (canceled)
